(19) United States
(12) Patent Application Publication
(10) Pub. No.: US 2005/0020201 A1
(43) Pub. Date: Jan. 27, 2005

(54) System and method for indexing and tracking multimedia streams for wireless multimedia transmission

(76) Inventors: Richard Doil Lane, San Diego, CA (US); Gordon Kent Walker, Poway, CA (US); Ramaswamy Murali, San Diego, CA (US); Chinnappa K. Ganapathy, San Diego, CA (US)

Correspondence Address: Qualcomm Incorporated;Patents Department, 5775 Morehouse Drive, San Diego, CA, 92121-1714, US

(21) Appl. No.: 10/616,585

(22) Filed: Jul. 9, 2003

(51) Int. Cl. H04H 1/00

(52) U.S. Cl. 455/3.01

(57) ABSTRACT

In addition to global index chunks that indicate the order of program portions in a multimedia stream carrying multiple multiplexed programs, index blocks are provided in data chunks of the stream that point to times when particular program portions arrive. This information can be used at the physical or transport layer of a wireless battery-powered receiver by, e.g., a simple state machine to energize the analog receiving circuitry only for as long as necessary to receive information pertaining to a desired program, thereby conserving battery power.

### FIELD OF THE INVENTION

The present invention relates generally to computer-based communication systems.

### BACKGROUND OF THE INVENTION

Digital multimedia data such as video and music can be transmitted wirelessly to mobile receivers, such as wireless telephones, for playing of the multimedia by users of the mobile receivers. Such data typically may be broadcast.

The multimedia can be formatted in accordance with Moving Pictures Expert Group (MPEG) standards such as MPEG-1, MPEG-2 (also used for DVD format), MPEG-4 and other block based transform codecs. Essentially, for individual video frames these multimedia standards use Joint Photographic Experts Group (JPEG) compression. In JPEG, the image of a single frame is typically divided into small blocks of pixels (usually 8×8 and/or 16×16 pixel blocks) that are encoded using a discrete cosine transform (DCT) function to transform the spatial intensity values represented by the pixels to spatial frequency values, roughly arranged, in a block, from lowest frequency to highest. Then, the DCT values are quantized, i.e., the information is reduced by grouping it into chunks by, e.g., dividing every value by 10 and rounding off to the nearest integer. Since the DCT function includes a progressive weighting that puts bigger numbers near the top left corner of a block and smaller numbers near the lower right corner, a special zigzag ordering of values can be applied that facilitates further compression by run-length coding (essentially, storing a count of the number of, e.g., zero values that appear consecutively, instead of storing all the zero values). If desired, the resulting numbers may be used to look up symbols from a table developed using Huffman coding to create shorter symbols for the most common numbers, an operation commonly referred to as “variable length coding”.

In any case, a JPEG-encoded stream represents horizontal lines of a picture, in much the same way as the underlying pixel data is arranged in a matrix of horizontal rows. It should be appreciated that while block based video encoding is being used as an example, the principals for indexing and tracking encompassed herein apply to other types of Audio and Video codecs and other forms of multimedia data.

It will be appreciated that JPEG compression results in lost information. However, owing to the phenomenon of human perception and the way that the above process works, JPEG compression can reduce a picture to about one-fifth of its original size with virtually no discernable difference and to one-tenth of its original size with only slight degradation.

Motion pictures add a temporal dimension to the spatial dimension of single pictures. Typical motion pictures have thirty frames, i.e., thirty still pictures, per second of viewing time. MPEG is essentially a compression technique that uses motion estimation to further compress a video stream.

MPEG encoding breaks each picture into blocks called “macroblocks”, and then searches neighboring pictures for similar blocks. If a match is found, instead of storing all of the DCT values for the entire block, the system stores a much smaller vector that-describes the movement (or not) of the block between pictures. In this way, efficient compression is achieved.

With more specificity, MPEG compression in general uses three kinds of video frames. Naturally, some frames, referred to as “intraframes” (also referred to as “reference frames”, or “I frames” and “information frames”), in which the entire frame is composed of compressed, quantized DCT values, must be provided (e.g., around once every two seconds). But in MPEG compression the remaining frames (e.g., 59) that make up the rest of the video for that second are very much smaller frames that refer to the intraframes, in accordance with MPEG compression principles. In MPEG parlance these frames are called “predicted” frames (“P frames”) and “bidirectional” frames (“B frames”), herein collectively referred to as “interframes”.

Predicted frames are those frames that contain motion vector references to the preceding intraframe or to a preceding predicted frame, in accordance with the discussion above. If a block has changed slightly in intensity or color, then the difference between the two frames is also encoded in a predicted frame. Moreover, if something entirely new appears that does not match any previous blocks, then a new block or blocks can be stored in the predicted frame in the same way as in an intraframe. Note that, as used herein, such a new block is not a “predetermined portion” of an intraframe in that it arises only upon the random introduction of a new object of arbitrary size and position in the frame.

In contrast, a bidirectional frame is used as follows. The MPEG system searches forward and backward through the video stream to match blocks (typically the nearest intra frame or predictive frame in each direction). Experience has shown that two bidirectional frames between each intra frame or predictive frame works well.

In any case, multimedia data including video that has I-frames, P-frames, and B-frames is typically transmitted using Internet Protocol (IP) packaging and transport techniques, which are compatible with almost all physical layers (i.e., with almost all physical transmission paths, wired or wireless, that might be used). While using IP has the benefit of compatibility with a large number of transmission systems, it can entail undesired overhead costs in certain applications, particularly in wireless applications, including requiring the wireless receiver to use more battery power than might be necessary to receive a desired program.

The present invention makes this critical observation by recognizing the following. Several multimedia programs might be transmitted on a single channel. Because data in IP is transmitted in data chunks, the programs can be multiplexed with each other to attain more efficient use of bandwidth. For example, a data chunk might contain a relatively large I-frame of one program, a relatively small P-frame of a second program, and small B-frame of a third program, and so on, so that the data chunk is filled up as much as possible. Periodically (e.g., every few seconds), an index chunk is transmitted that indicates the order of the channels in the data chunks, so that a receiver wishing to receive a particular program knows which parts of the data chunks it should reconstitute into the desired program and which other parts of the chunks it can ignore as belonging to other programs.

As currently implemented, the discrimination between desired program data and data pertaining to other programs is undertaken at the application level of the receiver. This means, however, that the underlying transport and physical layer components of the receiver—the radio portion, in wireless applications—must remain energized during reception of all program information in the received chunks, including information pertaining to other-than-desired programs. The present invention recognizes that such unnecessary power consumption looms large in the context of wireless receivers, which are typically powered by batteries.

### SUMMARY OF THE INVENTION

A communication method for wireless transmission of a multimedia stream having data chunks that carry information related to at least first and second programs and global index chunks that carry indexing information related to the data chunks includes, in at least some data chunks, establishing respective index blocks. The index block of a data chunk for a program indicates times associated with subsequent data chunks for that program. The method also includes, at a communication level other than an application level, using information in the index blocks to cause at least portions of a wireless receiver to be energized substantially only during times associated with a desired program and index blocks.

In a preferred embodiment, the portions of the wireless receiver include an analog receiver. The index blocks can be the first blocks of the respective data chunks. An index block of a first chunk can indicate times for individual program information for at least the next data chunk for the same program following the first chunk. Or, an index block of a first chunk of a program can indicate times for at least the next two to N (2-N) data chunks for that program following the first chunk. The number of times indicated N may depend on the channel characteristics including but not limited to the typical anticipated error profile. If desired, the program information can pertain to resolution divisions in a program and/or to temporal layer divisions and/or quality or SNR layer divisions in a program.

In another aspect, a wireless receiver of multimedia programs for displaying at least a desired one of the programs includes an analog receiver and a receiver controller receiving information in data chunks. The controller uses the information to cause the receiver to be energized substantially only during periods of reception of data pertaining to the desired one of the programs.

In still another aspect, a transmitting system for transmitting a multimedia stream including data chunks carrying information pertaining to at least first and second programs and global index chunks includes means for establishing, in at least first and second data chunks, at least respective first and second timing blocks indicating times associated with respective subsequent data chunks pertaining to the programs. In addition, within each individual program's timing block, there may be additional index data indicating times associated with multimedia layer access points within the program's data chunk (e.g. indexes pointing to the audio portion, text portion etc . . . ). With this feature, a receiving system can use the times to selectively energize a receiver of the receiving system.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is a schematic diagram of a multimedia stream according to the present invention;

FIG. 3 is a schematic diagram of a multimedia stream showing pointers to particular program portions; and

FIG. 4 is a flow chart of the overall logic of the invention.

### DETAILED DESCRIPTION OF THE PREFERRED EMBODIMENT

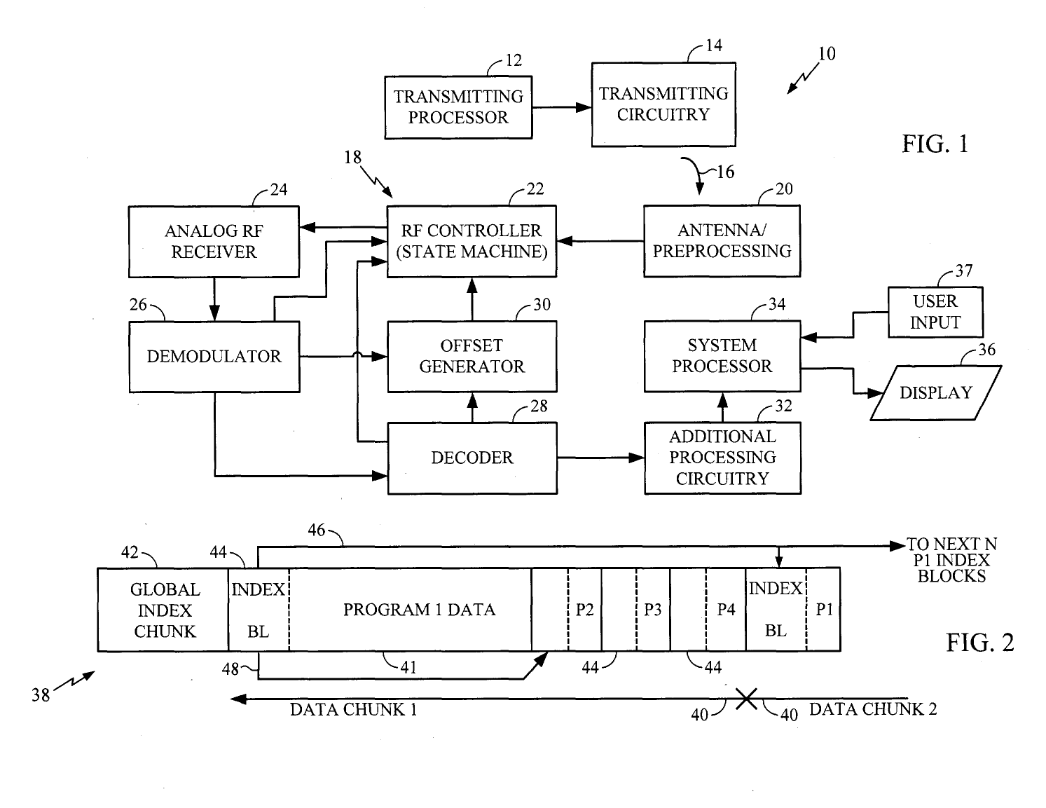

Referring initially to FIG. 1, a system is shown, generally designated 10, that includes a wireless broadcast transmitting system having a transmitting processor 12 and conventional transmitting circuitry 14 which wirelessly broadcasts, using a preferably unidirectional channel 16, digital multimedia content in the form of multimedia streams to wireless mobile station receivers 18 (only a single mobile station receiver 18 shown for clarity).

The multimedia streams can be from one or more sources that communicate with or are otherwise associated with the broadcast transmitting system. The system 10 can use, without limitation, CDMA principles, GSM principles, or other wireless principles including wideband CDMA (WCDMA), cdma2000 (such as cdma2000 1× or 3× air interface standards, for example), HDR, TDMA, or TD-SCDMA, and OFDM. The multimedia content can alternatively be provided over a bidirectional point-to-point link if desired, such as, e.g., a Bluetooth link or a 802.11 link or a CDMA link or GSM link.

The preferred receiver 18 shown in FIG. 1 includes an antenna 20 with conventional preprocessing (e.g., preamplifying) circuitry. The signal from the antenna 20 may be sent to an rf controller 22 that can include conventional circuitry for establishing gain, AGC, etc. in accordance with principles known in the art. The rf controller 22 can also include a state machine that implements the logic set forth herein to energize an analog rf receiver 24 only during periods when data that is associated with a user-desired program in a multimedia stream is present, as set forth further below.

In accordance with wireless principles known in the art, the output of the rf receiver 24 is sent to a demodulator 26, which demodulates the signal using, e.g., a Fast Fourier Transform or other demodulating paradigm to render encoded data bits. The data bits are send to a decoder 28 (e.g., convolutional, turbo, low-density parity-check) which decodes the bits and outputs a decoded bit stream. The decoded bit stream may be provided to an offset generator 30 which, if provided, generates on and off signals that are received and used by the rf controller 22. Also, the output of the decoder 28 may be fed back to the RF controller 22.

Also, the output of the decoder 28 is sent to additional processing circuitry 32. The preferred non-limiting additional processing circuitry can use an outer code, such as Reed-Solomon or other block cyclic codes (e.g., BCH) to further process the data, which can then be sent to a receiver system processor 34 for causing a multimedia program to be displayed on a display 36. The system processor 34 can incorporate the additional processing circuitry if desired. The user can indicate the desired program using an appropriate input device 37 that is part of the mobile station associated with the receiver 18.

As shown in FIG. 1, when an offset generator 30 is provided, the decoder 28 can send it indexing and channel data tracking data derived from the decoded bit stream. If an offset generator 30 is not provided, the decoder 28 optionally can send on/off data direct to the rf controller 22. Or, the preferred rf controller 22 can obtain the on/off information directly from the incoming signal as set forth further below. It is understood that alternately the on/off data could come from the output of the demodulator 26 and sent either to the offset generator 30 or directly to the rf controller 22.

FIG. 2 shows the details of a multimedia stream 38 of the present invention. In accordance with multimedia transmission principles known in the art, several programs can be sent in the stream 38. In the example shown, programs 1-4 are included in the stream. It is to be understood that while FIG. 2 shows the programs 1-4 in numeric order, the programs need not necessarily be packaged in numerical order. As illustrated in FIG. 2, the programs are multiplexed by filling some or all data chunks 40 (two data chunks 40 shown in FIG. 2 for illustration), with portions 41 of data (“frames”) in each data chunk 40 pertaining to each of the four exemplary programs in accordance with multiplexing principles known in the art.

In addition to the data chunks 40, global index chunks 42 can be provided periodically (e.g., every two seconds) to indicate the order of program data appearance in the multimedia stream. In the example shown, the programs 40 appear in numerical order, i.e., the first portion of each data chunk 40 pertains to program #1, the second portion to program #2, and so on. The global index chunks 42 may also provide metadata information, temporal location of the first byte of the first subsequent frame for each program (in the first following data chunk), and other programming information.

In accordance with the present invention, some or all data chunks 40 can include index or timing block(s) 44. Preferably, each individual program frame 41 of each data chunk 40 includes an index block 44, as indicated in dashed lines in FIG. 2. The index block 44 may be the first block of its frame 41. Each index block 44 contains what might be regarded as pointers to the temporal locations of the frames 41 of the same program in the subsequent data chunks 40, e.g., in the subsequent two to four data chunks, as indicated by the arrow 46 in FIG. 2, although only the temporal location one program frame ahead might be indicated. For clarity of disclosure, FIG. 2 shows only the pointers associated with program 1, it being understood that programs 2-4 include index blocks with similar pointers. Thus, an index block 44 in a program 1 frame of a data chunk 40 points to the temporal locations of the index blocks of the next few program 1 frames in subsequent data chunks 40, an index block 44 in a program 2 frame of a data chunk 40 points to the temporal locations of the index blocks of the next few program 2 frames in subsequent data chunks 40, and so on. Likewise, the index block 44 in a program 1 frame of a second data chunk 40 points to the temporal locations of the index blocks of the next few program 1 frames in subsequent data chunks 40. Thus, once a receiver 18 has successfully acquired a program channel (eg program 1) it can continually find successive frames 41 for that program without referencing or receiving the subsequent global index chunks 42. The reason for having an index block 44 point to multiple program frames 41 is to compensate for the expected packet losses typical of lossy transmission systems such as wireless cellular systems. If one program frame 41 is corrupted by packet errors the receiver simply delays until the next scheduled data chunk 40 for the next occurrence of the program frame 41. If the number of errors is larger than the total time represented by the latest index in the index list, the receiver simply returns to searching for the next global index chunks 42 and begins again.

The index blocks 44 may also contain pointers 48 to the next index block associated with the program that is associated with a “program down” keystroke, so that when a user changes programs by depressing a “program down” button on the user input 37, the rf controller need simply shift to receiving the previous program in the stream. For example, a program 2 index block contains not only pointers to the next few program 2 index blocks, but also to the next instance of program 1 index block which appears in the next data chunk 40. In a four program example, a program 1 index block contains not only pointers to the next few program 1 index blocks, but also to the next program 4 index block. Should the user depress a “program up” button, the receiver simply switches to the very next program data in the stream by using the length of the current program as an offset to find the beginning of the next program (eg if the current program was 2 the next program selected would be 3). After the user has selected a new program, the receiver can begin tracking that program by accessing its index block 44. In this way a receiver 18 can increment and decrement through program channels without needing to read the global index chunks 42.

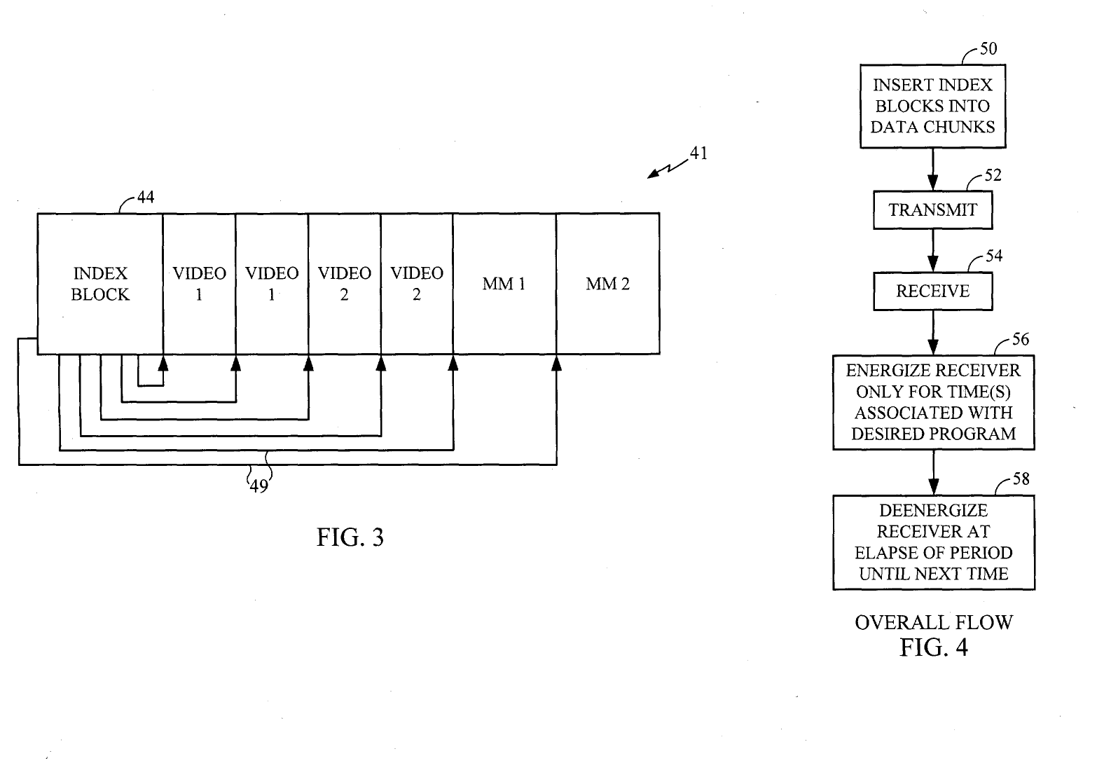

Moreover, as shown in FIG. 3 an index block 44 can contain not only pointers to subsequent program frame index blocks, but also pointers 49 to starting locations of particular program portions, such as various video layers and associated audio, multimedia portions of the program, etc., so that, if desired, the receiver can be energized only to receive video, audio, etc. Thus, an index block 44 may contain information pertaining to multimedia data divisions in a program (i.e., where a video 1 layer starts and where a video 2 later starts, and where Audio and other multimedia layers start).

In this way, the rf controller 22 is informed (directly from the received data or indirectly from the offset generator 30 and/or decoder 28 and/or the demodulator 26) when the rf receiver 24 must be energized to receive a particularly selected program/program portion/program layer, and to receive the next index block 44 associated with that program so that program data in, e.g., the next few,data chunks 40 can be received.

With the above disclosure in mind, attention is now directed to FIG. 4. Commencing at block 50, the transmitter processor 12 inserts or otherwise establishes the index blocks 44 in the multimedia stream 38. The stream is transmitted wirelessly at block 52 and received by the mobile station at block 54.

Proceeding to block 56, the receiver 24 is caused to be energized only during the times associated with the user-desired program/program portion/program layer, using the information in the index blocks 44. The receiver 24 is de-energized during other times (except for times associated with future index blocks 44). It may now be appreciated that the receiver 24 is controlled at the physical or transport layer and not at the application level. It can be appreciated that an alternative implementation could allow the application layer to control the receiver 24 but at the cost of additional delay and power consumption.

It is to be further appreciated that the program information in the index blocks 44 can pertain to resolution divisions in a program, and/or to video layer divisions in a program. That means that lower resolution mobile stations, e.g., QCIF (Quarter Common Intermediate Format 176×144 pixels) mobile stations, can cause their analog receiver to be energized only during periods of data reception required to support lower resolution display, whereas higher resolution mobile stations, e.g., CIF (Common Intermediate Format 352×288 pixels) mobile stations, can cause their analog receiver to be energized during periods of data reception required to support higher resolution display. In addition to resolution divisions, the multimedia data could be separated into quality, temporal or other divisions depending on the needs of the system, program, preferences etc.

Non-battery powered and/or wired systems may not benefit from battery power savings (though its always good to save power) but the BW and/or spectrum savings affored by the present invention would still apply and be useful to any multimedia delivery system, battery powered or not.

While the particular SYSTEM AND METHOD FOR INDEXING AND TRACKING MULTIMEDIA STREAMS FOR WIRELESS MULTIMEDIA TRANSMISSION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art; and that the scope of the present invention is accordingly to be limited by nothing other than the appended claims, in which reference to an element in the singular is not intended to mean “one and only one” unless explicitly so stated, but rather “one or more”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for” or, in the case of a method claim, the element is recited as a “step” instead of an “act”.

1. A communication method for wireless transmission of a multimedia stream having data chunks carrying information related to at least first and second programs and global index chunks carrying indexing information related to the data chunks, comprising:
in at least some data chunks, establishing respective index blocks, the index blocks indicating times associated with individual program information in subsequent data chunks; and
at a communication level other than an application level, using information in the index blocks to cause at least portions of a wireless receiver to be energized substantially only during times associated with a desired program and index blocks.

2. The method of claim 1, wherein the portions of the wireless receiver include an analog receiver.

3. The method of claim 1, wherein the index blocks are the first blocks of individual program frames in data chunks.

4. The method of claim 1, wherein an index block of a first program frame of a first data chunk indicates a time for a first program frame for at least the next data chunk following the first data chunk.

5. The method of claim 1, wherein an index block of a first program frame of a first data chunk indicates times for first program frames for at least the next two data chunks following the first data chunk.

6. The method of claim 1, wherein an index block of a first program frame of a first data chunk indicates times for first program frames for at least the next N data chunks following the first data chunk.

7. The method of claim 1, wherein the program information pertains to at least one of: resolution divisions in a program, quality divisions in a program, and temporal divisions in a program.

8. The method of claim 1, wherein the program information pertains to video layer divisions in a program.

9. The method of claim 1, comprising providing a state machine to undertake the act of using information in the index blocks to cause at least portions of a wireless receiver to be energized substantially only during times associated with a desired program.

10. The method of claim 1, wherein the index blocks further include back pointers associated with program portions in the same data chunk.

11. A wireless receiver of multimedia programs for displaying at least a desired one of the programs, comprising:
at least one analog receiver; and
at least one receiver controller receiving information in data chunks, the controller using the information to cause the receiver to be energized substantially only during periods of reception of data pertaining to the desired one of the programs.

12. The receiver of claim 11, comprising at least one demodulator receiving output of the analog receiver and demodulating the output.

13. The receiver of claim 11, comprising at least one decoder receiving encoded bits from the demodulator and outputting a decoded bit stream representing the desired one of the programs.

14. The receiver of claim 11, wherein the output of the decoder provides input to an offset generator representative of the periods of reception.

15. The receiver of claim 11, further comprising an offset generator providing input to the receiver controller representative of the periods of reception.

16. The receiver of claim 12, wherein the output of the demodulator provides input to the receiver controller representative of the periods of reception.

17. The receiver of claim 12, where the output of the demodulator provides input to an offset generator representative of the periods of reception.

18. The receiver of claim 11, wherein the receiver controller provides input to the analog receiver.

19. The receiver of claim 11, wherein the receiver controller is implemented by a state machine.

20. A transmitting system for transmitting a multimedia stream including data chunks carrying information pertaining to at least first and second programs and global index chunks, the transmitting system comprising:
means for establishing, in at least some data chunks, at least two timing blocks respectively indicating times associated with the first and second programs, whereby a receiving system can use the times to selectively energize at least a receiver of the receiving system.

21. The system of claim 20, wherein the timing blocks are the first blocks of respective program frames.

22. The system of claim 20, wherein a timing block of a first frame of a first program indicates a time for at least the next frame of the first program.

23. The system of claim 20, wherein a timing block of a first frame of a first program indicates times for at least the next two frames of the first program.

24. The system of claim 20, wherein a timing block of a first frame of a first program indicates times for at least the next N frames of the first program.

25. The system of claim 20, wherein the times pertain to at least one of: resolution divisions in a program, quality divisions, and temporal divisions

26. The system of claim 20, wherein the times pertain to video layer divisions in a program.

27. The system of claim 20, wherein a timing block associated with a first program contains a back pointer to at least one time associated with the second program.

28. A system for wireless transmission of a multimedia stream having data chunks carrying information related to at least first and second programs and global index chunks carrying indexing information related to the data chunks, comprising:
means for establishing, in at least some data chunks, respective index blocks, the index blocks indicating times associated with individual program information in subsequent data chunks; and
means for using, at a communication level other than an application level, information in the index blocks to cause at least portions of a wireless receiver to be energized substantially only during times associated with a desired program and index blocks.

29. The system of claim 28, wherein the portions of the wireless receiver include an analog receiver.

30. The system of claim 28, wherein the means for using includes a state machine.
